(19) United States
(12) Patent Application Publication
(10) Pub. No.: US 2025/0353537 A1
(43) Pub. Date: Nov. 20, 2025

(54) PUSHCHAIR SYSTEM CONVERTIBLE INTO A BICYCLE SEAT

(71) Applicants: Charlotte LEPAGE, Marseille (FR); Jean-Baptiste BARBAROUX, Marseille (FR); LIF (LAB), Marseille (FR)

(72) Inventors: Charlotte LEPAGE, Marseille (FR); Jean-Baptiste BARBAROUX, Marseille (FR); Patrick JOUFFRET, Marseille (FR); Mathieu LANZ, Marseille (FR); Emilien POTHET, Marseille (FR); Julien PRIMARD, Marseille (FR)

(73) Assignee: LIF (LAB), Marseille (FR)

(21) Appl. No.: 18/864,806

(22) PCT Filed: May 12, 2023
(86) PCT No.: PCT/FR2023/050687

§ 371 Date: Nov. 11, 2024

(30) Foreign Application Priority Data
May 12, 2022 (FR) FR2204503

(51) Int. Cl. B62B 7/12; B62B 7/06; B62B 9/12; B62B 9/20; B62J 1/16

(52) U.S. Cl. CPC B62B 7/12; B62B 7/064; B62B 9/12; B62B 9/20; B62J 1/16; B62B 2205/20; B62B 2206/006

(57) ABSTRACT

The invention relates to a stroller system (2) convertible into a bicycle seat comprising a rigid foldable chassis (4), a set of steerable front wheels (14) pivotally mounted about a front axis (X-X), a set of rear wheels (20) pivotally mounted about a rear axis (Y-Y), a device for locking the front wheel set in its deployed and folded positions, a removable fixing device (6) on a bicycle luggage rack, and a mechanism for locking and unlocking the rear wheel set able to cooperate with a stop member secured to the rear wheel set between a locking position in which it maintains the rear wheel set in its deployed position and an unlocking position in which it allows the rear wheel set to pivot towards its folded position, the rear wheel set being maintained in its folded position by the front wheel set when the latter is locked in its folded position.

### TECHNICAL FIELD

The present invention relates to the general field of strollers for children. It more specifically concerns a first-age and second-age adaptive stroller convertible into a bicycle seat for children.

### PRIOR ART

The systems aiming to facilitate the transport of children meet a fundamental need of families. They fall into two main categories: toys (tricycles, scooters, bicycles, balance bikes, etc.) and childcare products (strollers, bicycle seats, carrying bags, etc.). The present invention falls into this second category, and more specifically the category of strollers and bicycle seats.

As the decarbonization of the urban mobility accelerates with the climate change, the active mobility modes, and primarily bicycles (conventional or electrically assisted bicycles), are emerging as key vectors of this evolution.

One of the challenges taken into account by the present invention is to overcome the main obstacles encountered by parent-users wishing to switch from cars to bicycles. Indeed, these obstacles arise from the incompatibility between the need for a stroller and the use of a bicycle. This incompatibility is expressed in different ways: multiplicity of the stakeholders (parents, grandparents, child minders) in Children's Day (not all of them ride a bicycle), diversity of times and places in Children's Day (travel from and to home, nursery/school, park/square, shopping, etc.), mobility and rest of the child arrived at destination.

This problem has already been studied and has resulted in various technical solutions such as the systems for loading a stroller onto a bicycle, the strollers convertible into bicycles and the hybrid bicycle seats/strollers.

However, in the current state of developments, no proposed response has resulted in a fully satisfactory solution in terms of use, in particular.

Indeed, the systems for loading strollers onto a bicycle are generally difficult to use because their implementation is very dependent on the respective architectures of the two products to be assembled in the absence of a fixing standard. In addition, the strollers have most often not been designed with this in mind, so that their loading can interfere with the proper use of the bicycle, its balance, etc.

As for bicycles convertible into strollers, they are generally very bulky, heavy, expensive and do not satisfactorily fulfill the function of either a stroller or a bicycle. These products are then complements that are added to the family's objects, thus impacting the family's budget. They are also difficult to maneuver and park, which makes them poorly compatible with the constraints of families living in apartments in particular.

Hybrid bicycle seat/stroller solutions thus appear to be a preferred solution and various solutions of this type have been developed. Examples include publications FR 2,659,616, GB 2,538,053, U.S. Pat. No. 5,071,146, WO 01/66403 and WO 2016/003359, which describe various systems for child bicycle seats convertible into strollers.

Although these systems generally address the above-mentioned problem, they each have drawbacks. Thus, the system described in the publication WO 2016/003359 does not allow adjusting the backrest inclination and, more generally, proposes a typical seat base structure of a bicycle seat that does not fully meet the needs and uses of a stroller, particularly for newborns. In addition, this system cannot be folded for storage. As for the stroller described in publication GB 2,538,053, it is necessary to fold it before its loading onto the bicycle luggage rack.

Generally speaking, the known solutions for bicycle seat systems convertible into strollers are not very practical to use. Moreover, since they are childcare products, these solutions do not always comply with the precise and multiple normative frameworks (different standards exist for strollers and bicycle seats).

### DISCLOSURE OF THE INVENTION

The invention therefore relates to a stroller system convertible into a bicycle seat that does not have the aforementioned drawbacks.

In accordance with the invention, this aim is achieved thanks to a stroller system convertible into a bicycle seat able to be configured in a first deployed configuration allowing its use as a stroller and in a second folded configuration allowing its storage and/or its use as a bicycle seat, the stroller system comprising a rigid foldable chassis able to be fixed to a bicycle luggage rack both in a deployed configuration and a folded configuration, the chassis comprising:
a seat base structure with a backrest,
a set of steerable front wheels pivotally mounted about a front transverse axis of the chassis between a deployed position and a folded position,
a set of rear wheels pivotally mounted about a rear transverse axis of the chassis between a deployed position and a folded position,
at least one device for locking the front wheel set in its deployed position and in its folded position,
a removable fixing device on a bicycle luggage rack,
a pusher mounted on the chassis and whose length is adjustable between a high position in which it forms a handle for the stroller and a low position in which it forms a rear mechanical retainer for the backrest of the bicycle seat, and
at least one mechanism for locking and unlocking the rear wheel set positioned between the rear axis and the front axis of the chassis, the mechanism being able to cooperate with a stop member secured to the rear wheel set between a locking position in which it maintains the rear wheel set in its deployed position and an unlocked position in which it allows the rear wheel set to pivot towards its folded position, the rear wheel set being maintained in its folded position by the front wheel set when the latter is locked in its folded position.

The stroller system according to the invention is remarkable in particular in that it has two configurations, namely a first deployed and rolling configuration allowing its use as a stroller, and a second folded configuration allowing its storage and/or its use as a bicycle seat. More specifically, the stroller system can be installed on the luggage rack of the bicycle in an indiscriminate manner in a folded or unfolded configuration and consequently be folded or unfolded in an indiscriminate manner before or after its loading onto or unloading from the bicycle.

According to one embodiment, the rear wheel set locking and unlocking mechanism comprises a latch which is pivotally mounted on the chassis about a transverse axis located between the rear axis and the front axis and which includes a front lug able to come into abutment against a stop element secured to the front wheel set and a rear lug able to come into abutment against the stop member secured to the rear wheel set, the latch being mounted on a spring able to pivot the latch about its axis in a direction opposite to the direction of pivoting of the front and rear wheel sets when their configuration changes, and the stop member secured to the rear wheel set comprises a retractable strike able to move between a first position in which it comes into abutment against the rear lug of the latch to prevent the rear wheel set from pivoting and a second position in which it can freely pass over the rear lug.

According to another embodiment, the rear wheel set locking and unlocking mechanism comprises a cam secured in rotation to the front wheel set and cooperating with a follower member which is mounted on one side of the chassis and which comprises a front finger mounted on a spring to be maintained in abutment against the cam and a rear finger mounted on a spring, the rotation of the cam allowing the follower member to move between a first position in which the rear finger is in abutment against the stop member secured to the rear wheel set in order to prevent the latter from pivoting and a second position in which it releases the pivoting of the rear wheel set.

The front wheel set locking device can comprise at least one indexing peg manually movable between at least one locking position in which it is housed in a receptacle of the chassis and an unlocking position in which it is retracted out of the receptacle of the chassis, the indexing peg being mounted on a spring in order to maintain it in the locking position in the absence of manual action on it.

The front wheel set locking device can comprise two separate indexing pegs housed in two separate receptacles of the chassis when they are in the locking position.

According to another embodiment, the front wheel set locking device can comprise a lever controlled in rotation by the pusher between a locking position in which the lever makes it possible to block a locking bolt secured to the front wheel set in order to prevent the latter from pivoting, and an unlocking position in which the lever releases the locking bolt to allow the front wheel set to pivot, the locking bolt preventing the front wheel set from pivoting by the action of a spring in the absence of action on the lever.

The front wheel set can comprise two arms at the end of which at least one wheel is mounted and which are connected to each other only at their other end by the front transverse axis of the chassis so as to facilitate a loading onto a bicycle rack when the stroller system is in its deployed configuration.

Preferably, when moving from their deployed position to their folded position, the front and rear wheel sets pivot in the same direction of rotation towards the backrest of the seat base structure.

Also preferably, the stroller system further comprises removable bicycle seat accessories which are able to be assembled onto the stroller system when the latter is used as a bicycle seat.

The stroller system can further comprise a front handle located at the front of the chassis and a rear handle located at the level of the backrest of the seat base structure, the front and rear handles making it possible to manually lift the stroller during its loading or unloading.

The front wheel set can comprise at least one retractable footrest system.

### BRIEF DESCRIPTION OF THE DRAWINGS

FIG. 1 is a perspective view of a stroller system according to the invention in its deployed configuration.

FIG. 2 is a perspective view of the stroller system of FIG. 1 in its folded configuration.

FIGS. 3A and 3B are cross-sectional and top views of the chassis of the stroller system of FIGS. 1 and 2 showing the front wheel set locking devices in its deployed and folded positions, respectively.

FIGS. 4A and 4B are cross-sectional views of the chassis of the stroller system equipped with another embodiment of the front wheel set locking and unlocking mechanism.

FIGS. 5A and 5B are respectively top and side sectional views of the chassis of the stroller system of FIGS. 1 and 2 showing the rear wheel set locking mechanism in its deployed position.

FIGS. 6A and 6B are respectively top and side sectional views of the chassis of the stroller system of FIGS. 1 and 2 showing the rear wheel set locking mechanism in its folded position.

FIGS. 7A and 7B are side sectional views of the chassis of a stroller system according to one variant of embodiment of the invention showing a front wheel set locking device in its deployed and folded positions, respectively.

FIGS. 8A and 8B are cross-sectional views of the chassis of the stroller system equipped with a device for locking the front wheel set in the folded position according to another embodiment.

FIG. 9 is a view of the stroller system according to the invention in its folded configuration and complemented by removable bicycle seat accessories.

### DESCRIPTION OF THE EMBODIMENTS

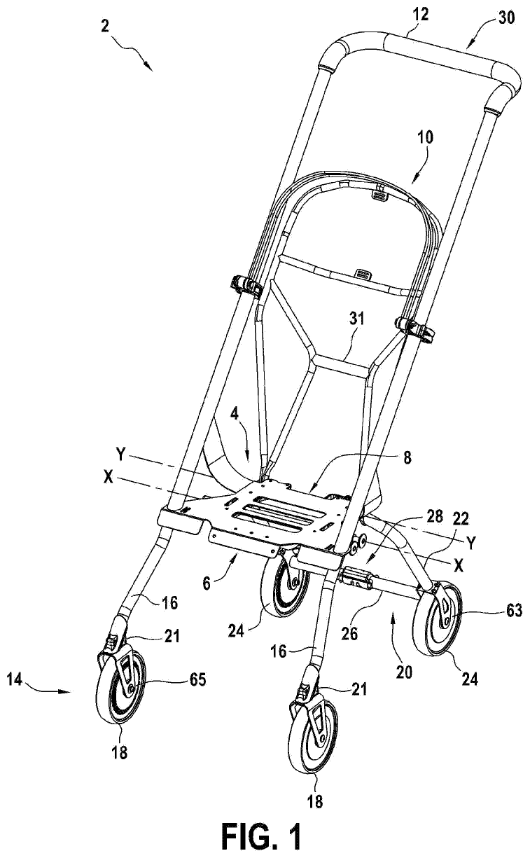

The invention relates to a system for a first-age and second-age adaptive stroller convertible into a bicycle seat for children such as the one represented in FIGS. 1, 2 and 9.

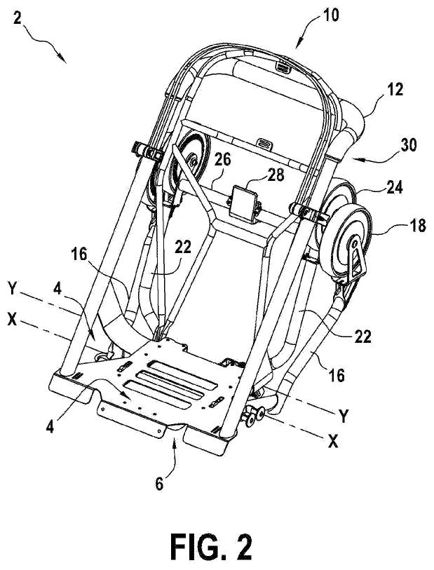

The stroller system 2 according to the invention can be handled between two configurations, namely a first configuration called “deployed” configuration (FIG. 1) allowing its use as a stroller, and according to a second configuration called “folded” configuration (FIG. 2) allowing its storage and/or its use as a bicycle seat.

The stroller system 2 comprises a rigid foldable chassis 4 able to be fixed on a bicycle luggage rack (not represented in the figures) both when the stroller system is in its deployed configuration and in its folded configuration.

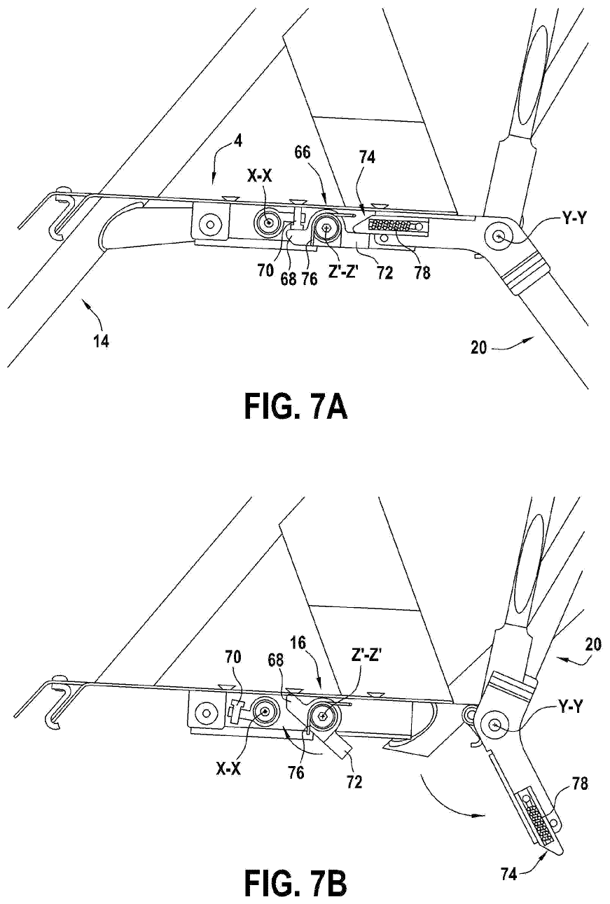

For this purpose, the chassis 4 comprises a removable fixing device 6 on a bicycle luggage rack. Preferably (but without limitation), this removable fixing device corresponds to the device described in patent application FR 2200378 filed by the Applicant on 17 Jan. 2022 and whose content is fully incorporated by reference. In this case represented in FIG. 7, the female plate 6a of the removable fixing device 6 is fixed under a lower face of the chassis and cooperates with the male plate 6b which is fixed on the bicycle luggage rack. Of course, other removable fixing devices can be envisaged.

The chassis 4 also comprises a seat base structure 8 provided with a reclining backrest 10, the whole being covered with a cover having a protective hood against rain and sun (not represented in the figures).

A set of steerable front wheels 14 is pivotally mounted about a front transverse axis X-X of the chassis between a deployed position (FIG. 1) and a folded position (FIG. 2). As described in detail later, the folding of the front wheel set is carried out backward.

More specifically, the front wheel set comprises two front arms 16 at the end of which at least one wheel 18 is mounted and which are connected to each other only at their other end by the front transverse axis X-X of the chassis.

In other words, this front wheel set is devoid of a bar connecting the front arms together at the level of the wheels 18, which facilitates a loading onto a bicycle rack when the stroller system is in its deployed configuration.

Moreover, the front arms 16 of the front wheel set advantageously comprise at least one retractable footrest system.

As represented in FIG. 1, the front wheel set can also comprise a system 21 for blocking the wheels in rotation and for orienting the wheels in the direction of travel.

The chassis 4 further comprises a rear wheel set 20 which is pivotally mounted between a deployed position (FIG. 1) and a folded position (FIG. 2) about a rear transverse axis Y-Y of the chassis. As described in detail later, the folding of the rear wheel set is carried out backward and is subject to the prior unlocking of the front wheel set 14.

More specifically, the rear wheel set 20 comprises two rear arms 22 at the end of which at least one wheel 24 is mounted. The rear arms are connected, on the one hand to each other at their end provided with the wheels by a bar 26, and on the other hand to the chassis 4 at their end opposite to the wheels at the level of the rear transverse axis Y-Y of the chassis.

Advantageously, the rear wheel set 20 further comprises a brake system whose actuation is carried out by means of a lever 28 mounted on the bar 26.

The stroller system according to the invention further comprises a pusher 30 mounted on the chassis 6 and provided at an upper end with a handle 12 for holding and pushing the stroller system.

The length of the pusher 30 is adjustable (for example being telescopic) between a high position corresponding to the deployed configuration as a stroller and a low position corresponding to the folded configuration as a bicycle seat in which it forms a rear mechanical retainer for the backrest of the bicycle seat.

The stroller system according to the invention also comprises a front handle (not represented in the figures) positioned at the front of the chassis, between the child's legs, and a rear handle 31 positioned at the rear of the backrest of the seat base. These handles make it possible to carry the stroller system, in particular when loading it onto or unloading it from a bicycle luggage rack.

The stroller system according to the invention also comprises a device for locking the front wheel set in its deployed position and in its folded position.

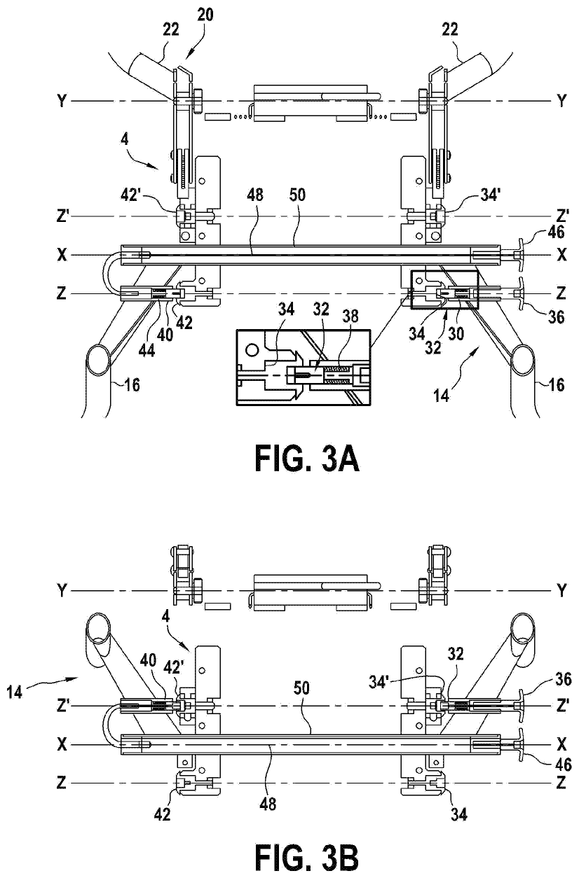

In the embodiment represented in FIGS. 3A and 3B, the front wheel set locking device comprises a main indexing peg 32 which is manually movable between two locking positions in which it is housed in receptacles 34, 34′ positioned on one of the sides of the chassis 4 (FIGS. 3A and 3B), and an unlocking position in which it is retracted out of the receptacles of the chassis.

More specifically, when it is in a first locking position (FIG. 3A), the main indexing peg 32 is housed laterally in a first receptacle 34 which is positioned on one of the sides of the chassis and which extends along a transverse axis Z-Z located ahead of the front transverse axis X-X of the chassis. This first locking position makes it possible to lock the front wheel set in its deployed position.

When it is in a second locking position (FIG. 3B), the main indexing peg 32 is housed laterally in a second receptacle 34′ which is positioned on the same side of the chassis and which extends along a transverse axis Z′-Z′ located between the front transverse axis X-X and the rear transverse axis Y-Y of the chassis. This second locking position makes it possible to lock the front wheel set in its folded position.

Moreover, the main indexing peg 32 can be manually actuated by means of a handle 36 and is mounted on a spring 38 in order to maintain it in its locking positions in the absence of manual action on it.

In this embodiment, the front wheel set locking device comprises an auxiliary indexing peg 40 which is also manually movable between two locking positions in which it is housed in receptacles 42, 42′ positioned on the opposite side of the chassis 4 (FIGS. 3A and 3B), and an unlocking position in which it is retracted out of the receptacle of the chassis.

More specifically, when it is in a first locking position (FIG. 3A) and corresponding to the first locking position of the main indexing peg 32, this auxiliary indexing peg 40 is housed laterally in a first receptacle 42 which is aligned along the transverse axis Z-Z of the chassis with the first receptacle 34.

Similarly, when it is in the second locking position (FIG. 3B) and corresponding to the second locking position of the main indexing peg 32, this auxiliary indexing peg 40 is housed laterally in a second receptacle 42′ which is aligned along the transverse axis Z′-Z′ of the chassis with the second receptacle 34′.

This auxiliary indexing peg 40 is mounted on a spring 44 in order to maintain it in its locking positions in the absence of a manual action on it. In addition, it can be actuated from a handle 46 positioned on the same side of the chassis as the handle 36 for actuating the main indexing peg 32. For this purpose, the auxiliary indexing peg 40 is connected to the handle 46 by means of a cable 48 passing through a tube 50 centered on the front transverse axis X-X of the chassis.

In this way, in order to unlock the front wheel set locking device with the aim of moving the front wheel set from its deployed position to its folded position (and vice versa), it will be necessary to manually pull at the same time on the two handles 36, 46 in order to retract the main 32 and auxiliary 40 indexing pegs out of their respective receptacle.

The presence of two indexing pegs (the main indexing peg and the auxiliary indexing peg) thus makes it possible to reinforce the security of the front wheel set locking device by avoiding any untimely action on it.

Of course, it is possible to provide only the main indexing peg. Similarly, in a configuration with two indexing pegs, their respective actuating handles can be positioned on each side of the chassis or be combined into a single double-action handle located on one side of the chassis.

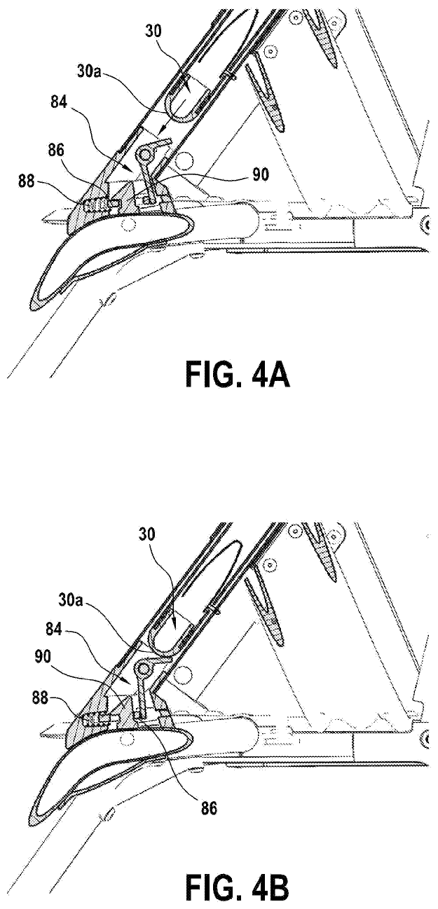

In connection with FIGS. 4A and 4B, another embodiment of the locking and unlocking mechanism of the front wheel set will be described.

In this other embodiment, the lower end 30a of the pusher 30 is able to actuate the rotation of a lever 84 mounted in rotation on the chassis. The rotation of the lever 84 makes it possible to move in translation a sheet metal 86 provided with a cutout between a locking position (FIG. 4A)—maintained at rest in this position by a spring 88—and an unlocking position (FIG. 4B).

More specifically, the forward translation of the sheet metal 86 (under the action of the pusher) makes it possible to align its cutout with a locking bolt 90 secured to the front wheel set to release the locking bolt and thus allow the free rotation of the front wheel set (FIG. 4B).

When the pusher 30 is deployed for the use of the stroller system, the spring 88 re-engages the locking mechanism by translation of the sheet metal 86 backward. The locking mechanism being in the closed position at rest, the locking bolt 90 is designed so as to be capable of directly actuating the sheet metal 86 in the closing direction only.

A safety can be envisaged to prevent any involuntary unlocking of the mechanism. For example, a pin of the crutch type (not represented in FIGS. 4A, 4B), positioned on one side of the pusher could act as a stop that must be actuated to allow the pusher to be fully depressed and to interact with the lever 84 via its lower end 30a.

The stroller system according to the invention also comprises a mechanism for locking and unlocking the rear wheel set.

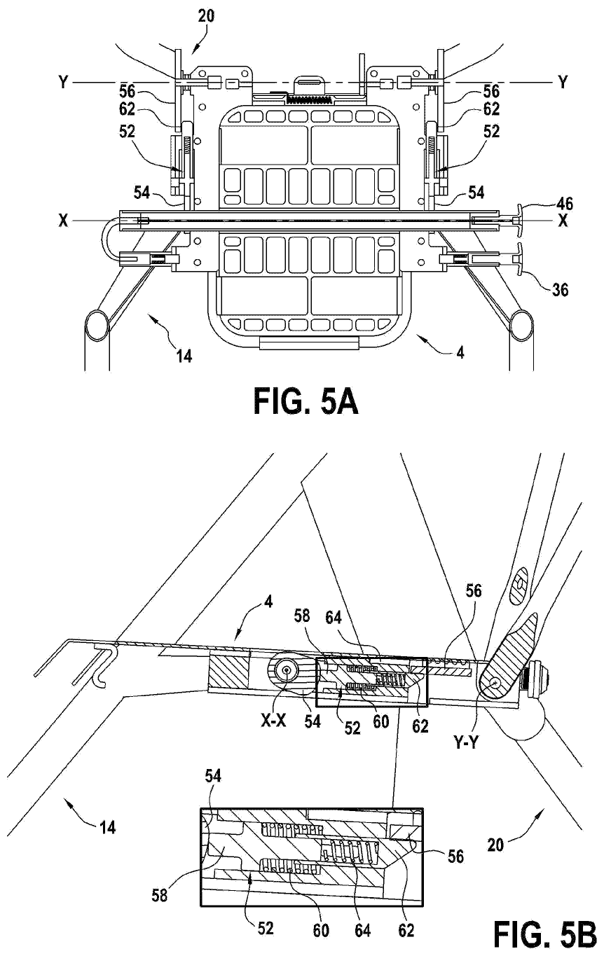

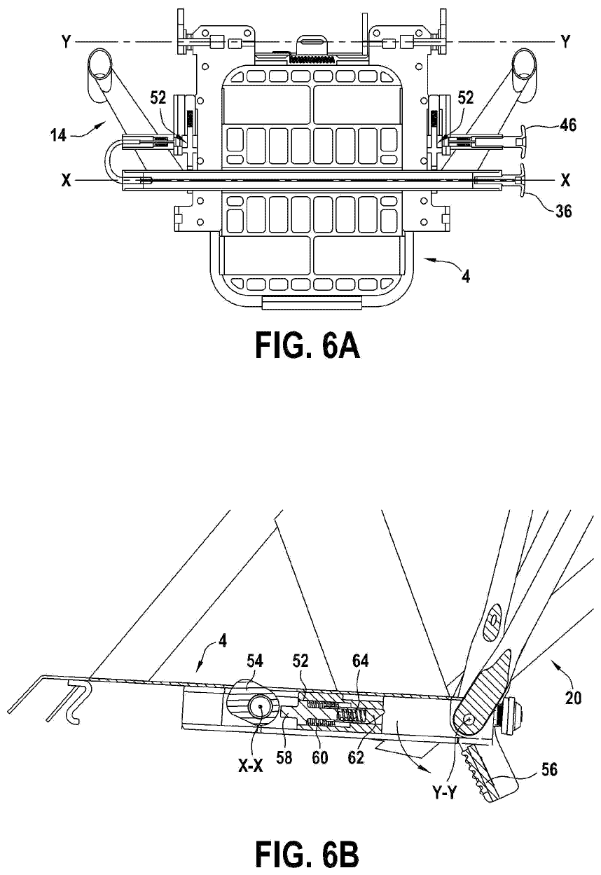

In connection with FIGS. 5A, 5B, 6A and 6B, a first embodiment of such a mechanism will be described.

In this embodiment, this mechanism comprises in particular a cam 54 secured in rotation to the front wheel set which is mounted on each side of the chassis 4 and which cooperates with a follower member 52 also mounted on each side of the chassis.

Each follower member 52 comprises a front finger 58 which is mounted on a spring 60 to be maintained in abutment against the cam 54 secured to the front wheel set.

Each follower member 52 also comprises a rear finger 62 which is mounted on another spring 64. The rotation of the cam 54 makes it possible to move the follower member 52 between a first position (corresponding to the spring 60 in the compressed position) in which the rear finger 62 comes into abutment against a stop member 56 secured to the rear wheel set (and formed by a plate) to prevent the latter from pivoting (FIGS. 5A and 5B) and a second position in which it releases the pivoting of the rear wheel set (FIGS. 6A and 6B).

The operation of this mechanism for locking and unlocking the rear wheel set is as follows.

In the deployed configuration of the stroller system, the front and rear wheel sets are in the deployed position (FIGS. 5A and 5B). In this position, the follower member 52 is in a position such that its rear finger 62 is in abutment against the plate 56 secured to the rear wheel set. The rear wheel set therefore cannot pivot about the rear transverse axis Y-Y to come into the folded position.

When the front wheel set begins to pivot backward about the front transverse axis X-X in order to come into the folded position, the front finger 58 of the follower member will follow the cam path 54 secured to the front wheel set. This movement will result in a forward translation of the chassis of the follower member 52, and therefore of the rear finger 62 which will retract and no longer come into abutment against the plate 56 secured to the rear wheel set (FIGS. 6A and 6B). The rear wheel set is thus unlocked and can then pivot backward.

Preferably, the rear wheel set comprises stop elements 63 able to come into abutment against stop elements 65 of the front wheel set to allow the latter to drive the rear wheel set when the stroller system moves from its deployed configuration to its folded configuration.

The locking of the front wheel set in its folded position is then ensured by the front wheel set locking device described above. As for maintaining the rear wheel set in its folded position, it is ensured by the front wheel set when the latter is locked in its folded position.

The stroller system is moved from its folded configuration to its deployed configuration as follows. First, the front wheel set is unlocked by means of the locking device and then it is pivoted forward. This action also makes it possible to drive the rear wheel set forward. During this movement, if the rear wheel set is hindered by an obstacle during its rotation, the plate 56 secured to the rear wheel set presses against the rear finger 62 of the follower member, which causes the rear finger to retract to its second position. Once the plate 56 has passed over the rear finger of the follower member, the latter deploys under the effect of the spring 64 to its first position, causing a blocking of the rear wheel set in its deployed position. As for the front wheel set, it is locked in its deployed position by the locking device described above.

In connection with FIGS. 7A and 7B, a second embodiment of the rear wheel set locking and unlocking mechanism will be described.

In this second embodiment, it is intended to position on the two opposite sides of the chassis 4 a latch 66 which is able to pivot about a transverse axis Z′-Z′ of the chassis, this axis Z′-Z′ being located between the front axis X-X and the rear axis Y-Y and being parallel to them.

The latches 66 each carry a front lug 68 which is able to come into abutment against a stop element 70 secured to the front wheel set and a rear lug 72 which is able to come into abutment against a stop member 74 secured to the rear wheel set.

In addition, each latch 66 is mounted on a spring 76 able to pivot the latch about its axis Z′-Z′ in a direction opposite to the direction of pivoting of the front and rear wheel sets when their configuration changes.

Moreover, in this embodiment, the stop member secured to the rear wheel set is formed by a retractable strike 74 which is mounted on a spring 78 and which is able to move between a first position (corresponding to the spring 78 in the rest position) in which it comes into abutment against the rear lug 72 of the latch 66 to prevent the rear wheel set 20 from pivoting (FIG. 7A) and a second position (corresponding to the spring 78 in the compressed position) in which it can freely pass over the rear lug 72 (FIG. 7B).

The operation of this mechanism for locking and unlocking the rear wheel set is as follows.

In the deployed configuration of the stroller system, the front and rear wheel sets are in the deployed position (FIG. 7A). In this position, the latch 66 is maintained by the stop element 70 secured to the front wheel set in a position such that its rear lug 72 comes into abutment against the retractable strike 74 of the rear wheel set. The rear wheel set therefore cannot pivot about the rear transverse axis Y-Y to come into the folded position.

When the front wheel set begins to pivot backward about the front transverse axis X-X to come into the folded position, the stop element 70 will pivot at the same time as the front wheel set, thus allowing the latch 66 to pivot in the opposite direction about the axis Z′-Z′ (under the effect of the spring 76). This pivoting of the latch will cause its rear lug 72 to pivot, which will allow releasing the rotation of the rear wheel set. The rear wheel set is thus unlocked and can then pivot backward (FIG. 6B), the rest of the movement being identical to what was described in connection with the previous embodiment of the rear wheel set locking and unlocking mechanism.

The stroller system is moved from its folded configuration to its deployed configuration as follows. First, the front wheel set is unlocked by means of the locking device and then it is pivoted forward. This action also allows driving the rear wheel set forward. During this movement, if the rear wheel set is hindered by an obstacle during its rotation, the retractable strike 74 secured to the rear wheel set presses against the rear lug 72 of the latch 66, which causes the retractable strike to retract to its second position. Once the retractable strike has passed over the rear lug of the latch, it deploys under the effect of the spring 78 to its first position, causing the rear wheel set to be blocked in its deployed position. As for the front wheel set, it is locked in its deployed position by the locking device described above.

Various advantageous characteristics of the stroller system according to the invention will now be described in its various embodiments.

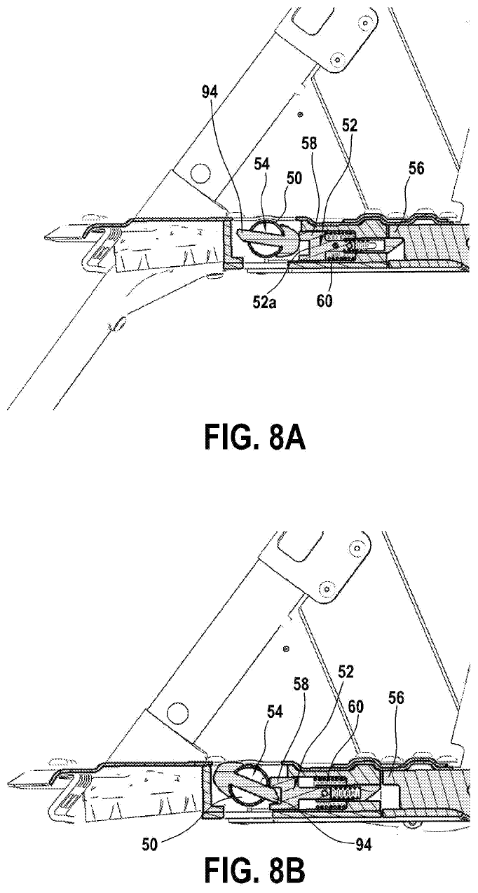

In connection with FIGS. 8A and 8B, another device for locking the front wheel set in the folded position will now be described. This locking device is an evolution of the rear wheel set locking and unlocking mechanism according to the first embodiment (relating to FIGS. 5A, B, 6A and 6B).

In this variant of embodiment, the cam 54 which is secured to the front wheel set comprises a rear finger 94 which is positioned opposite to the head of the cam. This rear finger 94 protrudes from the opposite side of the tube 50 through which the front transverse axis X-X of the chassis passes. The face of this rear finger which first comes into contact with the follower member 52 during a counterclockwise rotation is beveled.

Moreover, the follower member 52 comprises, at the level of its front finger 58, a machined head whose shape integrates a first recess 52a made on the front face and a second recess (not represented in the figures) made on one side. The first recess 52a has a shape complementary to that of the rear finger 94 of the cam with which it cooperates.

During the rotation of the front wheel set from the deployed position to the folded position, the spring 60 pushes the follower member 52 forward. The latter then remains in contact with the cam head 54, then with the tube 50. As the end of the rotation approaches, the rear finger 94 of the cam in turn comes into contact with the front finger 58 of the follower member via its beveled face.

The shape of the rear finger 94 is such that the rotation of the tube 50 exerts a force inducing the translation of the front finger 58 of the follower member against the force of the spring 60. Once passed and aligned with the first recess 52a of the front finger 58 of the follower member, the latter translates forward under the effect of the spring 60, then blocking the rotation of the cam 54, and consequently any rotation of the front wheel set. The latter is thus locked in the folded position.

The device for locking the front wheel set in the folded position as described above is normally closed and cannot be unlocked without external action on the front finger 58 of the follower member so as to force its translation backward against the force exerted by the spring 60.

This action is carried out using an unlocking lever (not represented in the figures) which is positioned on the side of the device implementing the follower member 52 in order to be made accessible to the user.

Such an unlocking lever is rotatable and comprises a manual action handle at one end and an interaction rod at the opposite end, each of these ends being located on either side of the axis of rotation of the unlocking lever. The interaction rod is complementary to the second recess made on one side of the front finger 58 of the follower member.

The user's action on the unlocking lever induces a force on the front finger 58 of the follower member which is contrary to the force of the spring 60. This results in a backward translation of the follower member. This movement then releases the rear finger 94 from the cam and allows the rotation of both the tube 50 and the front arm 16 of the front wheel set.

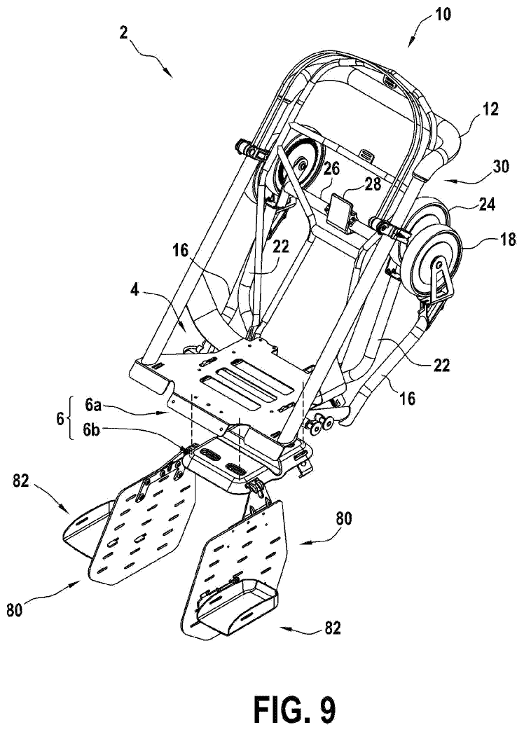

As represented in FIG. 9, advantageously, the stroller system 2 further comprises removable bicycle seat accessories which are able to be assembled on the removable fixing device, in particular on the male plate of the device when the latter complies with the device described in patent application FR 2200378.

For example, these accessories are two side plates 80 which are used to protect the child's legs from the spokes of the rear wheel of the bicycle and allow fixing removable and retractable footrests 82.

1. A stroller system convertible into a bicycle seat able to be configured in a first deployed configuration allowing its use as a stroller and in a second folded configuration allowing its storage and/or its use as a bicycle seat, the stroller system comprising a rigid foldable chassis able to be fixed to a bicycle luggage rack both in a deployed configuration and a folded configuration, the chassis comprising:
a seat base structure with a backrest,
a set of steerable front wheels pivotally mounted about a front transverse axis of the chassis between a deployed position and a folded position,
a set of rear wheels pivotally mounted about a rear transverse axis of the chassis between a deployed position and a folded position,
at least one device for locking the front wheel set in its deployed position and in its folded position,
a removable fixing device on a bicycle luggage rack,
a pusher mounted on the chassis and whose length is adjustable between a high position in which it forms a handle for the stroller and a low position in which it forms a rear mechanical retainer for the backrest of the bicycle seat, and
at least one mechanism for locking and unlocking the rear wheel set positioned between the rear axis and the front axis of the chassis, the mechanism being able to cooperate with a stop member secured to the rear wheel set between a locking position in which it maintains the rear wheel set in its deployed position and an unlocking position in which it allows the rear wheel set to pivot towards its folded position, the rear wheel set being maintained in its folded position by the front wheel set when the latter is locked in its folded position.

2. The stroller system according to claim 1, wherein:
the rear wheel set locking and unlocking mechanism comprises a latch which is pivotally mounted on the chassis about a transverse axis located between the front axis and the rear axis and which includes a front lug able to come into abutment against a stop element secured to the front wheel set and a rear lug able to come into abutment against the stop member secured to the rear wheel set, the latch being mounted on a spring able to pivot the latch about its axis in a direction opposite to the direction of pivoting of the front and rear wheel sets when their configuration changes, and
the stop member secured to the rear wheel set comprises a retractable strike able to move between a first position in which it comes into abutment against the rear lug of the latch to prevent the rear wheel set from pivoting and a second position in which it can freely pass over the rear lug.

3. The stroller system according to claim 1, wherein the rear wheel set locking and unlocking mechanism comprises a cam secured in rotation to the front wheel set and cooperating with a follower member which is mounted on one side of the chassis and which comprises a front finger mounted on a spring to be maintained in abutment against the cam and a rear finger mounted on a spring, the rotation of the cam allowing the follower member to move between a first position in which the rear finger is in abutment against the stop member secured to the rear wheel set in order to prevent the latter from pivoting and a second position in which it releases the pivoting of the rear wheel set.

4. The stroller system according to claim 1, wherein the front wheel set locking device comprises at least one indexing peg manually movable between at least one locking position in which it is housed in a receptacle of the chassis and an unlocking position in which it is retracted out of the receptacle of the chassis, the indexing peg being mounted on a spring in order to maintain it in the locking position in the absence of manual action on it.

5. The stroller system according to claim 4, wherein the front wheel set locking device comprises two separate indexing pegs housed in two separate receptacles of the chassis when they are in the locking position.

6. The stroller system according to claim 1, wherein the front wheel set locking device comprises a lever controlled in rotation by the pusher between a locking position in which the lever makes it possible to block a locking bolt secured to the front wheel set in order to prevent the latter from pivoting, and an unlocking position in which the lever releases the locking bolt to allow the front wheel set to pivot, the locking bolt preventing the front wheel set from pivoting by the action of a spring in the absence of action on the lever.

7. The stroller system according to claim 1, wherein the rear wheel set comprises stop elements able to come into abutment against stop elements of the front wheel set to allow the latter to drive the rear wheel set when the stroller system moves from its deployed configuration to its folded configuration.

8. The stroller system according to claim 1, wherein the front wheel set comprises two arms at the end of which at least one wheel is mounted and which are connected to each other only at their other end by the front transverse axis of the chassis so as to facilitate loading onto a bicycle rack when the stroller system is in its deployed configuration.

9. The stroller system according to claim 1, wherein, when moving from their deployed position to their folded position, the front and rear wheel sets pivot in the same direction of rotation towards the backrest of the seat base structure.

10. The stroller system according to claim 1, further comprising removable bicycle seat accessories.

11. The stroller system according to claim 1, further comprising a front handle located at the front of the chassis and a rear handle located at the level of the backrest of the seat base structure, the front and rear handles making it possible to manually lift the stroller during its loading or unloading.

12. The stroller system according to claim 1, wherein the front wheel set comprises at least one retractable footrest system.
